(19) United States
(12) Patent Application Publication
(10) Pub. No.: US 2024/0033728 A1
(43) Pub. Date: Feb. 1, 2024

(54) MICROFLUIDIC PROCESSING SYSTEMS

(71) Applicant: Hewlett-Packard Development Company, L. P., Spring, TX (US)

(72) Inventors: Viktor Shkolnikov, Palo Alto, CA (US); Alexander Govyadinov, Corvallis, OR (US)

(73) Assignee: Hewlett-Packard Development Company, L. P., Spring, TX (US)

(21) Appl. No.: 17/876,622

(22) Filed: Jul. 29, 2022

(51) Int. Cl. B01L 3/00; B01L 7/00

(52) U.S. Cl. CPC B01L 3/502715; B01L 3/52; B01L 7/00; B01L 2200/027; B01L 2200/16; B01L 2300/18

(57) ABSTRACT

A microfluidic processing system can include a reagent delivery network including an inlet microfluidic channel fluidly coupled to an outlet microfluidic channel via a microfluidic cross-channel. The microfluidic cross-channel can include a constriction region and a reagent storage chamber. The microfluidic processing system can also include a resistor positioned along the inlet microfluidic channel at a location to redirect fluid through the constriction region and into a reagent storage chamber, and process microfluidics fluidly coupled downstream from the outlet microfluidic channel.

### BACKGROUND

Microfluidic systems and devices have applicability for use within a wide range of industries, including pharmaceutical, life science research, medical research, and forensic applications to name a few. For example, these types of systems and devices can be used to evaluate or analyze fluids using very small quantities of sample and/or reagent to interact with the sample than would otherwise be used with full-scale analysis devices or systems.

### BRIEF DESCRIPTION OF THE DRAWINGS

FIGS. 1-6 depict schematic views of various example reagent delivery networks for use in microfluidic processing systems in accordance with the present disclosure;

FIG. 7 is a schematic view of an example microfluidic processing system with a sample-receiving chamber fluidly coupled with an inlet microfluidic channel of a reagent delivery network in accordance with the present disclosure;

FIG. 8 is a schematic view of an example microfluidic processing system with a sample-receiving chamber as part of processing microfluidics that are fluidly coupled with an outlet microfluidic channel of a reagent delivery network in accordance with the present disclosure;

FIG. 9 is a schematic view of an example microfluidic processing system with multiple reagent delivery networks fluidly coupled to processing microfluidics, e.g., a microfluidic processing channel, in parallel in accordance with the present disclosure;

FIG. 10 is a schematic view of an example microfluidic processing system with multiple reagent delivery networks fluidly coupled together in series in accordance with the present disclosure;

FIG. 11 is a schematic view of an example microfluidic processing system including a multiplexing reagent delivery network fluidly coupled to processing microfluidics that includes multiple processing components in accordance with the present disclosure; and

FIG. 12 is a flow diagram of an example method of processing an analyte in accordance with the present disclosure.

### DETAILED DESCRIPTION

Microfluidic systems and devices can permit the analysis of a fluid on the micro-scale. These devices utilize smaller volumes of a fluid and reagents during the analysis than would otherwise be used for a full-scale analysis. In addition, microfluidic systems and devices can also allow for parallel analysis thereby providing faster analysis of a fluid. For example, during sample analysis, a reagent can interact with the sample fluid to cause a reaction. However, introducing the reagent during sample analysis can increase the cost and demand higher skills associated with the analysis, as well as increase time associated with conducting sample analysis and potentially increase the possibility of error. As an example, microfluidic processing systems of the present disclosure can be used for a variety of processes that may be tailored by an end user, depending on what reagents and/or processes may be useful. For example, in a system where there is the ability for multiplexing (or the ability to sequentially add reagent from a reagent delivery network or multiple reagent delivery network), the reagent storage chambers described herein may store any of a number of reagents, such as enzymes, chelating agents, primers for nucleic acid amplifications, reactants, etc. Thus, when multiplexing within a microfluidic network and/or multiplexing using multiple microfluidic networks connected in parallel or series fludically, reagents may be selected by an end user to be used additively or sequentially as may be desired for a given application. In some instances, decisions can be made by a user or a machine as to what to include next in a process based on results from a prior step, leveraging flexibility for on the fly processing, e.g., diagnostics, amplification, assays, cheating, enzyme processing, etc.

In accordance with examples of the present disclosure, a microfluidic processing system includes a reagent delivery network including an inlet microfluidic channel fluidly coupled to an outlet microfluidic channel via a microfluidic cross-channel. The microfluidic cross-channel in this example includes a constriction region and a reagent storage chamber. A resistor is positioned along the inlet microfluidic channel at a location to redirect fluid through the constriction region and into a reagent storage chamber, and the processing microfluidics are fluidly coupled downstream from the outlet microfluidic channel. In some examples, the processing microfluidics can include surface-activated magnetizing microparticles contained therein. In other examples, the processing microfluidics can include a thermocycling heater downstream from the reagent delivery network. The processing microfluidics can likewise include fluid movement components to direct fluid within the processing microfluidics or to eject fluid from the processing microfluidics. In other examples, the processing microfluidics can include a sample-receiving port or chamber to receive analyte-containing sample fluid at a location upstream from where the outlet microfluidic channel is fluidically coupled with the processing microfluidics. In some more specific examples, the processing microfluidics can include a secondary inlet microchannel or port positioned downstream from the sample-receiving port or chamber. The reagent storage chamber can contain reagent to be mixed or reconstituted by fluid passing through the constriction region and into the reagent storage chamber. The resistor can be adapted to operate at a power density sufficient to break a capillary retention meniscus at the constriction region and deliver fluid from the inlet microfluidic channel and into the reagent storage chamber. In some more specific examples, the microfluidic processing system can be adapted for multiplexing. For example, multiple microfluidic cross-channels can fluidically independently couple the inlet microfluidic channel with the outlet microfluidic channel in series. Thus, the multiple microfluidic cross-channels can include the microfluidic cross-channel (as described above), as well as a second microfluidic cross-channel having a second reagent storage chamber. A second resistor can be positioned along the inlet microfluidic channel at a second location to cause the fluid to flow through the second constriction region and into the second reagent storage chamber. Actuation of the resistor can cause the fluid to flow through the constriction region but does not cause the fluid to flow through the second constriction region; and likewise, actuation of the second resistor can cause the fluid to flow through the second constriction region and does not cause the fluid to flow through the constriction region.

In another example, a method of processing an analyte includes forming a capillary retention meniscus at a constriction region of a microfluidic cross-channel branching off from an inlet microfluidic channel. In this example, the microfluidic cross-channel also includes a reagent storage chamber downstream from the constriction region. The method further includes actuating a resistor positioned along the inlet microfluidic channel at a location to generate a pressure change to break the capillary retention meniscus, flowing the fluid through the constriction region and into the reagent storage chamber to combine with a reagent to form a reagent-containing fluid, and introducing the reagent-containing fluid into the processing microfluidics through an outlet microfluidic channel. In further detail, the method includes processing an analyte in combination with the reagent from the reagent-containing fluid at a location within the processing microfluidics. In some examples, the fluid can be an analyte-containing sample fluid and the reagent-containing fluid formed in the reagent storage chamber includes the analyte. In other examples, the method can include combining the reagent-containing fluid with an analyte-containing sample fluid at or after introducing the reagent-containing fluid into the processing microfluidics, e.g., analyte introduced upstream from where the reagent-containing fluid is introduced into the processing microfluidics. In other examples, the method can include moving the analyte along the processing microfluidics using magnetizing microparticles having an affinity for the analyte. In some examples, the method can include thermocycling the analyte within the processing microfluidics in the presence of reagent received from the reagent delivery network. In still other examples, after introducing the reagent-containing fluid into the processing microfluidics, the method can include forming a second capillary retention meniscus at a second constriction region of a second microfluidic cross-channel branching off from an inlet microfluidic channel. The second microfluidic cross-channel can include a second reagent storage chamber downstream from the second constriction region. In this example, the method can further include actuating a second resistor positioned along the inlet microfluidic channel at a second location to generate a pressure change to break the second capillary retention meniscus, flowing the fluid through the second constriction region and into the second reagent storage chamber to combine with the second reagent to form a second reagent-containing fluid, and introducing the second reagent-containing fluid into the processing microfluidics through the outlet microfluidic channel.

When discussing the microfluidic processing systems and/or the methods of processing sample fluids (containing analytes), such discussions can be considered applicable to one another whether or not they are explicitly discussed in the context of that example. Thus, for example, when discussing reagent delivery networks in the context of microfluidic processing systems, such disclosure is also relevant to and directly supported in the context of the methods, and vice versa.

Terms used herein will be interpreted as the ordinary meaning in the relevant technical field unless specified otherwise. In some instances, there are terms defined more specifically throughout or included at the end of the present disclosure, and thus, these terms are supplemented as having a meaning described herein.

Microfluidic Processing Systems

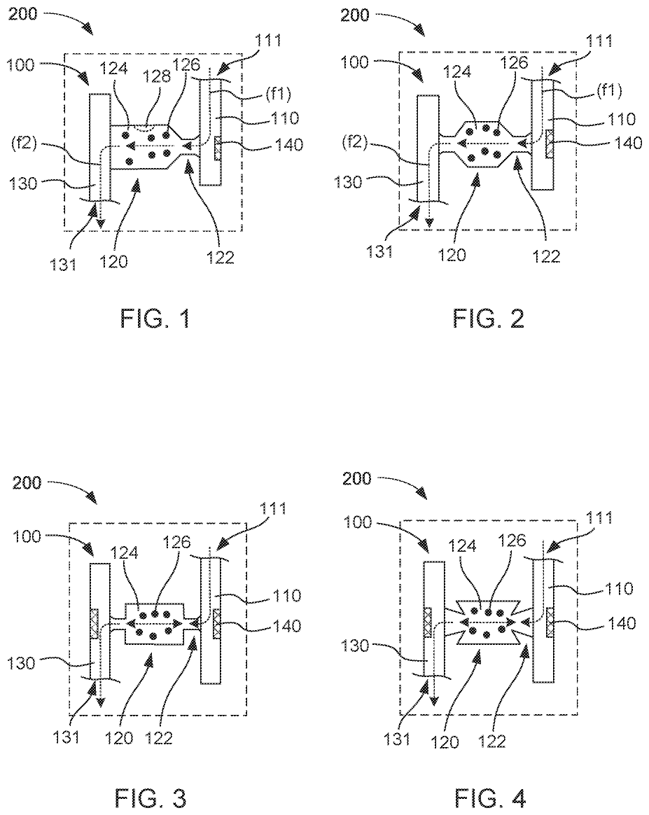

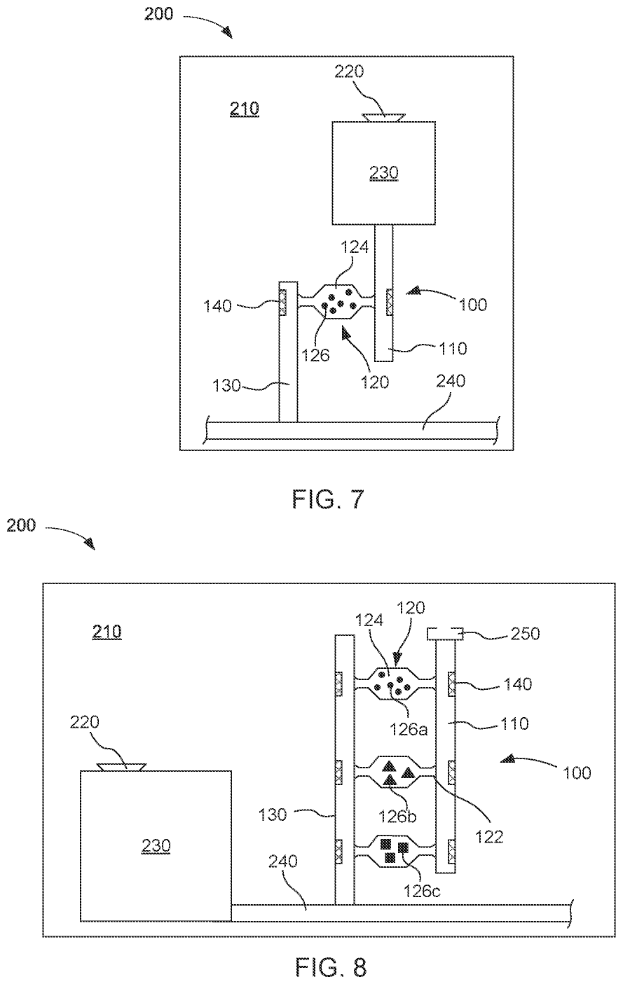

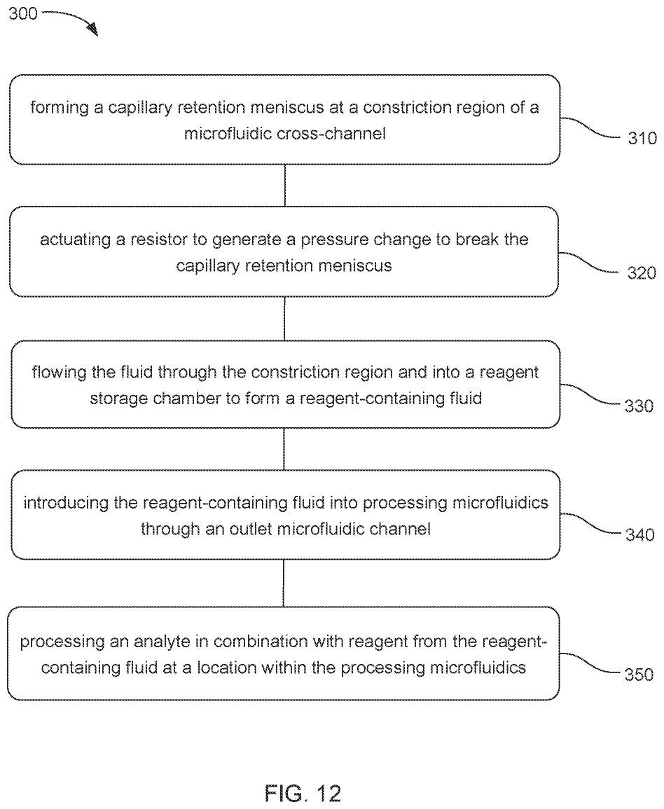

FIGS. 1-11 reference various microfluidic processing systems or portions thereof. For example, FIGS. 1-6 depict various example reagent delivery networks that can be present as part of the microfluidic processing systems of the present disclosure, FIGS. 7-11 depict various example microfluidic processing systems more holistically, and FIG. 12 illustrates example methods of the present disclosure. These examples can include various features, with several features common from example to example. However, with respect to FIGS. 1-11, the reference numerals used to refer to various features are the same throughout to avoid confusion, even though the reagent delivery networks and the microfluidic processing systems can have structural differences, as shown. Furthermore, it is understood that any feature or component described in the FIGS. or elsewhere herein can be used with any other feature or component.

Referring now to Fla 1, a schematic view of a reagent delivery network 100 as part of a microfluidic processing system 200 is shown that can include an inlet microfluidic channel 110, a microfluidic cross-channel 120 branching off from the inlet microfluidic channel, an outlet microfluidic channel 130 having a side-wall opening connected to the microfluidic cross-channel to receive fluid from the microfluidic cross-channel, and a resistor 140 operable to generate a pressure sufficient to break the capillary retention meniscus when fluid is situated within the inlet microfluidic channel. The microfluidic cross-channel can branch off from the inlet microfluidic channel and can include a constriction region 122 having a size suitable to form a capillary retention meniscus and a reagent storage chamber 124 having reagent 126 therein. The reagent storage chamber may further include a venting port 128 to allow for the exiting of solvent and/or gas from the reagent storage chamber as the reagent storage chamber is filled through the constriction region. In some examples, the venting port can be sealed with a protective film to minimize or prevent exposure of the reagent to external environmental conditions. The protective film may be removable, puncturable, or the like. A venting port can be present in any of the examples presented herein.

In further detail, the inlet microfluidic channel 110 can include an ingress opening 111 that permits flowing of a fluid (f) into the microfluidic cross-channel 120. The outlet microfluidic channel 130 can include an egress opening 131 that permits flowing of a fluid out of the microfluidic cross-channel. The inlet microfluidic channel and the outlet microfluidic channel can independently have a cross-sectional channel average size or a diameter that can range from 10 μm to 100 μm. In other examples, the inlet microfluidic channel and the outlet microfluidic channel can have a cross-sectional channel average size or a diameter (perpendicular to the direction of fluid flow) that can independently range from 10 μm to 50 μm, from 50 μm to 100 μm, from 25 μm to 75 μm, from 10 μm to 40 μm, from 30 μm to 90 μm, or from 40 μm to 80 μm. The inlet microfluidic channel and the outlet microfluidic channel can independently have a linear pathway, a curved path, a pathway with turns, a branched pathway, a serpentine pathway, or any other pathway configuration. In some examples, the inlet microfluidic channel and the outlet microfluidic may be arranged parallel to one another in the reagent delivery network.

The microfluidic cross-channel 120 can connect the inlet microfluidic channel 110 to the outlet microfluidic channel 130, as mentioned. The microfluidic cross-channel may branch off from a sidewall of the inlet microfluidic channel and may be connected to a side-wall opening of the outlet microfluidic channel. The microfluidic cross-channel may form a right angle with respect to the inlet microfluidic channel, the outlet microfluidic channel, or a combination thereof, though other angles can likewise be used. In the examples shown, the inlet microfluidic channel, outlet microfluidic channel, and the microfluidic cross-channel can form an H-like configuration. In yet other examples, the microfluidic cross-channel can form an angle that is not a right angle, and thus, the angle of the cross-channel may be acute or obtuse relative to the direction of fluid flow along through the inlet microfluidic channel and into the microfluidic cross-channel. Likewise, the microfluidic cross-channel can form an angle that is acute or obtuse relative to the direction of fluid flow from within the outlet microfluidic channel.

The microfluidic cross-channel 120 can have a reagent storage region 124 having a cross-sectional channel average size or a diameter (perpendicular to the direction of fluid flow) that can range from 5 μm to 30 μm. In some examples, the reagent storage region can have a cross-sectional channel average size or a diameter that can range from 10 μm to 20 μm, from 5 μm to 25 μm, from 5 μm to 15 μm, from 10 μm to 30 μm, from 15 μm to 30 μm, or from 20 μm to 30 μm. The microfluidic cross-channel 120 can include a constriction region(s) that can have a cross-sectional channel average size or a diameter (perpendicular to the direction of fluid flow) ranging from 5 μm to 20 μm, from 5 μm to 10 μm, or from 5 μm to 15 μm, with the proviso that the constriction region is smaller in average size or diameter than the reagent storage region of the microfluidic cross-channel. The constriction region(s) and in some instances the reagent storage region may have a cross-sectional channel average size or a diameter that is smaller than a cross-sectional channel average size or a diameter of the inlet microfluidic channel, the outlet microfluidic channel, or a combination thereof.

The constriction region 122 can have a cross-sectional channel average size or a diameter suitable to form a capillary retention meniscus, A capillary retention meniscus can form along at a gas-liquid interface of the construction region. As a fluid is flowed through the inlet microfluidic channel, the outlet microfluidic channel, or a combination thereof, a gas-liquid interface may form at the constriction region of the microfluidic cross-channel. The capillary retention meniscus can act as a valve which can prevent fluid from flowing further in the reagent delivery network. Thus, as mentioned, the microfluidic cross-channel may include a single constriction region 122 upstream relative to the reagent storage chamber 124 or may include dual constriction regions located upstream and downstream of the reagent storage chamber (as shown in FIGS. 3-6).

The reagent delivery network 100 can further include a resistor(s) 140. In some examples a resistor can be operable to generate a pressure above a pressure threshold of a capillary retention meniscus in an amount sufficient to break the capillary retention meniscus or push the capillary retention meniscus into the reagent storage chamber thereby allowing a fluid to enter the reagent storage chamber when fluid is situated within the inlet microfluidic channel. The meniscus can be formed in some examples due to the presence of the constriction region 122 where the inlet microfluidic channel 110 interfaces with the microfluidic cross-channel 120. The resistor can create a burst of pressure or a pressure pulse above the pressure threshold of the capillary retention meniscus. The pressure can expand and burst or push the capillary retention meniscus out of the constriction region.

The resistor(s) 140 can be sized and shaped to have a power sufficient to generate said pressure. In an example, a resistor can have a width ranging from 4 μm to 100 μm and can have an aspect ratio from 1:1 to 1:100. A power density of the resistor can range from 100 MW/m² to 1,000 MW/m², from 100 MVV/m² to 500 MW/m², from 250 MW/m² to 750 MW/m², or from 500 MW/m² to 1,000 MW/m². A resistor can be operable to generate a voltage ranging from 5 V to 400 V, from 100 V to 300 V, from 200 V to 4000 V from 5 V to 150 V, from 5 V to 40 V, or from 5 V to 75 V.

In an example, a resistor can be located across from the microfluidic cross-channel along the inlet microfluidic channel, the outlet microfluidic channel, or a combination thereof. In an example, a resistor can be located along an inlet microfluidic channel across from the constriction region. A resistor in said location can push a gas bubble forming the capillary retention meniscus into the reagent storage chamber, burst a gas bubble forming the capillary retention meniscus, or push a fluid into and/or out of the reagent storage chamber. In some examples, a reagent delivery network can include a resistor along an inlet microfluidic channel and an outlet microfluidic channel. The inclusion of two resistors along opposing ends of the reagent storage chamber can generate back and forth pressure which can push and pull a fluid in and out of the reagent storage chamber, thereby providing a mixing force. A resistor along the outlet microfluidic channel may be positioned to push or pull fluid through the reagent storage chamber. The resistors can also be positioned to function as pumps which can control fluid delivery into microfluidic channels.

The reagent storage chamber 124 can have a size and shape suitable to contain a reagent 126 therein. In some examples the reagent storage chamber may have an interior space suitable to contain 0.1 ng to 100 ng of reagent. In yet other examples, the reagent storage chamber may have an interior space suitable to contain from 0.1 ng to 0.5 ng, from 1 ng to 5 ng, from 5 ng to 50 ng, from 10 ng to 50 ng, from ng to 75 ng, or from 75 ng to 100 ng of reagent. In some examples, a configuration of the reagent storage chamber can be square, rectangular, polygonal, circular, or another configuration. Furthermore, the reagent storage chamber may include reagent, or reactants therein.

In some examples, the reagent may be a dried reagent that can be reconstituted by interact with a fluid when passed through the constricted region and into the reagent storage chamber. The term “dried reagent” as used herein, does not indicate that the reagent is dry at every point in time, such as during manufacture, loading, or dispersing of the reagent therein, To illustrate, dried reagent can be loaded (dispersed) in a carrier fluid to form a loading fluid (to load the reagent at the reagent storage chamber). The carrier fluid may be removed by heating the carrier fluid to evaporate the carrier fluid off, by lyophilizing the reagent delivery network in a lyophilizes, freeze-dryer, desiccator, or the like.

The reagent 126 can vary based on the intended use of the reagent delivery network 124. For example, the reagent can include nucleic acid primers when conducting a chain reaction assay. In other examples, the reagent can include secondary antibodies when conducting ELISA sandwich assays. In still other examples, a reagent can be a mixture of reagents. For example, a mixture of dried reagents could include a PCR mastermix. A PCR mastermix could include polymerases, magnesium salt, buffer, bovine serum albumin (BSA), primers, or combinations thereof. In some examples, the reagent can further include optical markers such as intercalating dye, TaqMan probes, or the like.

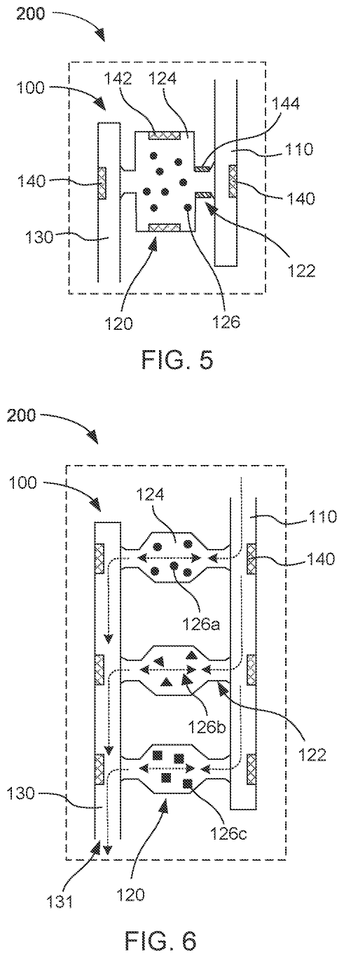

Notably, FIGS. 2-5 depict similar features that are commonly indicated with the same reference numerals as shown in FIG. 1, including the various example microfluidic processing systems 200 with different arrangements of respective reagent delivery networks 100. For example, FIG. 2 is similar to that shown in FIG. 1, except that the microfluidic cross-channel 120 includes a constricted region 122 at both ends thereof. FIG. 3 and FIG. 4 are also similar to that shown in FIG. 2, except that the shapes of the cross-channel and the constricted regions are also shaped differently. For example, the microfluidic cross-channel can be shaped to increase a bursting pressure threshold of a capillary retention meniscus formed. In this type of structure, the microfluidic cross-channel can include tapered or pointed sidewalls extending outward from the reagent storage chamber towards the constriction region, as illustrated in FIG. 4. When a bursting pressure threshold is generated, the capillary retention meniscus may burst, and fluid may be permitted to flow further downstream into the microfluidic cross-channel, a reagent storage chamber, and/or an outlet microfluidic channel. The structure of FIG. 5 is similar to that shown in FIG. 3, except that the reagent storage chamber 124 has a larger volume relative to the cross-sectional size of the constriction region 120, as well as the presence of chamber resistors 142 and a sensor 144, as described in greater detail hereinafter. Furthermore, FIGS. 3-6 each include examples where there is a resistor in both the inlet microfluidic channel and the outlet microfluidic channel, which provides the added benefit of allowing for bi-directional flow or mixing in the microfluidic cross-channel. There are also other differences as will be pointed out hereinafter.

In further detail regarding FIG. 5, the reagent delivery network 100 may further include a sensor 144. The sensor can be located near the constriction region. The sensor can be operable to determine the presence of a capillary restriction meniscus. In some examples, the sensor can include a wet-dry sensor. A dry-sensor state may indicate a presence of a capillary retention meniscus. A wet-sensor state may indicate that a capillary retention meniscus has burst and can indicate a presence of fluid. A sensor can send feedback to a controller. Following feedback from the sensor, the controller can determine whether further actuation of the resistor, chamber resistor, or combination thereof is desired.

In this example, the reagent delivery network 100 can further include a chamber resistor 142 in the microfluidic cross-channel 120. In some examples, a single chamber resistor can be located in the reagent storage chamber. The chamber resistor can provide an upward force and gravity can provide a downward force, thereby admixing the fluid and the reagent. In other examples, two chamber resistors can be located within the reagent storage chamber with chamber resistors being positioned across from one another. A chamber resistor can permit cross-directional fluid flow from the fluid flow pathway along the reagent delivery network. The cross-directional fluid flow can cause fluid to flow up and down within the reagent storage chamber. The up and down fluid flow can permit agitation of the fluid and the reagent therein and can increase mixing of the fluid with the reagent. A power density of the chamber resistor can range from 75 MW/m² to 1,000 MW/m², from 100 MW/m² to 300 MW/m², from 200 MW/m² to 500 MW/m², from 500 MW/m² to 650 MW/m², or from 800 MW/m² to 1,000 MW/m². A chamber resistor can be operable to generate a voltage ranging from 5 V to 400 V, from 100 V to 300 V, from 5 V to 150 V, from 5 V to 75 V, from 5 V to 40 V, or from 200 V to 300 V. The resistor(s) 140, chamber resistor(s) 142, or combination thereof can be coupled to a controller (not shown). The controller can be a part of the reagent delivery network or separate from the reagent delivery network. The controller can be operable to actuate the resistor, chamber resistor, or combination thereof permitting selective actuating of said resistor.

In further detail, as shown by way of example in FIG. 6, some reagent delivery networks may include structures suitable for multiplexing, including networks with multiple microfluidic cross-channels 120 between the inlet microfluidic channel 110 and the outlet microfluidic channel 130. For example, in FIG. 6 there are three microfluidic cross channels, each including a constriction region 122 and a reagent storage chamber 124. In this example, the various reagent storage chambers contain three different reagents, 126a, 126b, and 126c, which can be reconstituted at the same time or sequentially, for example, depending on when its corresponding resistor 140 is energized. The use of multiple different reagents can allow for a reaction in series with a sample fluid or can allow for multiple different reagents to be tested against one sample fluid, or can be used for various nucleic amplification processes, for example. To illustrate, each of the three reagent storage chambers shown in FIG. 6 can include a different set of nucleic acid primers, and these primers can be reconstituted in sequence for amplification downstream from the reagent delivery network. Other reagents may likewise be used as may be desirable for a given application.

Various microfluidic processing systems 200 are illustrated in FIGS. 7-11, and can include any of the reagent delivery networks 100 described herein and/or illustrated in FIGS. 1-6. The reagent delivery networks may not be referenced in as great of detail as in FIGS. 1-6, but those details are incorporated into the microfluidic processing system examples herein. In some examples, the microfluidic processing systems include reagent delivery networks that can be connected to or include other microfluidic or processing components, and can be supported by a substrate 205 (or even multiple substrates), such as that shown by way of example in FIGS. 7-11.

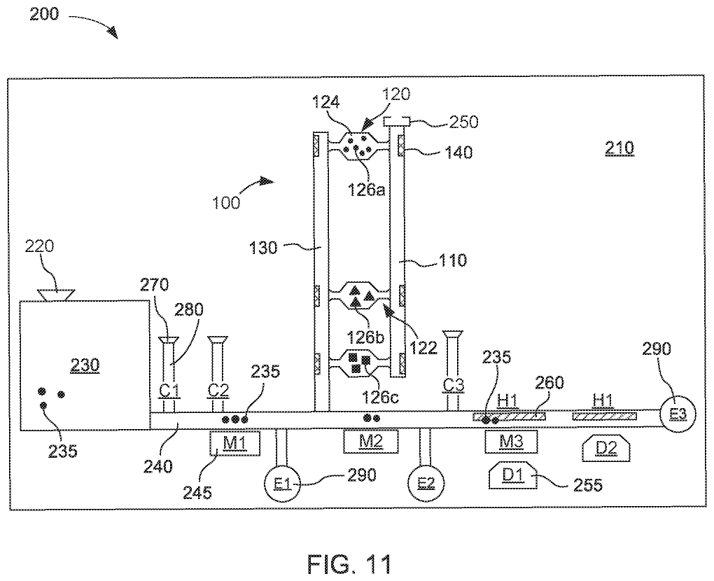

As shown in FIG. 7, a microfluidic processing system 200 can include a substrate 205, a sample port 220 fluidly coupled to an inlet microfluidic channel, and a reagent delivery network 100. In this example, the sample port is fluidly coupled to the inlet microfluidic channel via a sample-receiving chamber 230, but could include the sample-receiving port coupled directly to the inlet microfluidic channel (not shown). Thus, the reagent delivery network can include the structure shown or other similar structures by way of example as that shown in FIGS. 1-6. The outlet microfluidic channel 130 illustrates a fluidic interface or fluidic junction 135 between the reagent delivery network 100 and the processing microfluidics 210, which in this example is partially illustrated as a microfluidic processing channel 240. In addition to the microfluidic processing channel shown in this example, the processing microfluidics can include many other components, such as many of those shown in greater detail in FIG. 11 hereinafter.

In this particular example (shown at FIG. 7) as well as in the examples shown in FIGS. 8-11, the substrate may be a single layer or a multi-layer substrate. A material of the substrate can include SU-8, glass, silicon, polydimethylsiloxane (PDMS), polystyrene, polycarbonate, polymethyl methacrylate, poly-ethylene glycol diacrylate, perflouroaloxy, fluorinated ethylenepropylene, polyfluoropolyether diol methacrylate, polyurethane, cyclic olefin polymer, Teflon, copolymers, and combinations thereof. In some examples, the microfluidic substrate can include a hydrogel, ceramic, thermoset polyester, thermoplastic polymer, or a combination thereof. In other examples, the microfluidic substrate can include silicon. In still other examples, the substrate can include a low-temperature co-fired ceramic. In a further example, the substrate can include SU-8. The substrate may be optically transparent and/or include an optically transparent area, which may be useful when optical detectors are implemented, such as for assay and/or amplification readout. “Optically transparent” indicates that a material of the substrate (or a portion thereof) is of a material that permits at least 90% of a wavelength of light within an emission range of a light source or a detection range of an optical detector to pass through the optically transparent area.

In this example, as shown in FIG. 7, the sample port 220 may be configured to allow for the introduction of a sample fluid, e.g., analyte-containing fluid, into the microfluidic processing system 200 through the reagent delivery network 100. Thus, in some examples, the sample port can be fluidly coupled to the inlet microfluidic channel 110. This fluidic coupling can be direct or indirect. For example, the sample port may be directly coupled to the inlet microfluidic channel without intervening structures in-between. In other examples, a sample port can be coupled to the sample-receiving chamber 230 and the sample-receiving chamber can be coupled to the inlet microfluidic channel, as illustrated by way of example in FIG. 7.

In other examples, such as shown in FIGS. 8-11, the sample fluid or analyte-containing fluid can be introduced outside of the reagent delivery network, e.g., somewhere along the processing microfluidics 210. For example, as shown in FIG. 8, the processing microfluidics can include a sample port 220 coupled to a sample-receiving chamber 230, which can also be fluidly coupled to a microfluidic processing channel 240. In this example, the microfluidic processing channel can be fluidly coupled to the reagent delivery network 100 at the outlet microfluidic channel 130 at a fluidic junction 135. When fluidly coupled to the outlet microfluidic channel, a carrier fluid or buffer solution, for example, can be flowed into the reagent delivery network and into the inlet microfluidic channel to disperse or dissolve the reagent 126a, 126b, 126c still further downstream in one or more of the reagent storage chambers 124, resulting in a reconstituted reagent that is carried downstream via the outlet microfluidic channel and into the microfluidic processing channel. This configuration includes an inlet port 250, separate of the sample port.

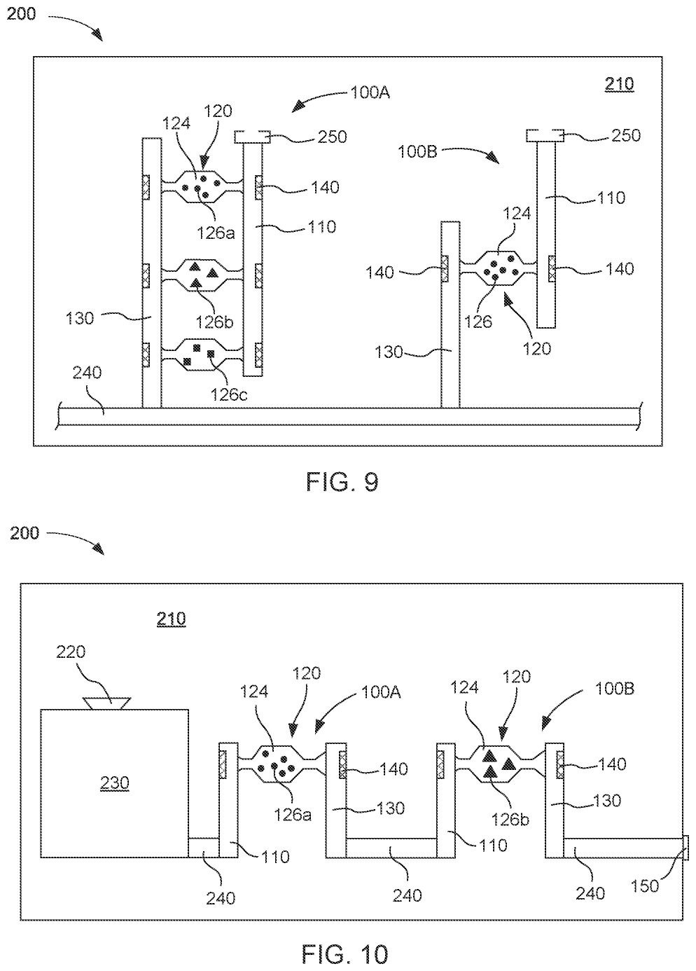

FIG. 9 and FIG. 10 depict other examples of microfluidic processing systems 200 where multiple reagent delivery networks 100A and 100B are connected in parallel or in series. As shown in FIG. 9, multiple reagent delivery networks are shown connected to a common microfluidic processing channel 240 in parallel. Thus, processing from these multiple reagent delivery networks can occur independently of one another and feed the microfluidic processing channel separately to work together or independent of one another.

On the other hand, as shown in FIG. 10, the microfluidic processing channels 100A and 100E may be fluidly coupled together by segments of the processing microfluidics 210, e.g., multiple sections of microfluidic processing channel 240, so that fluid flowing through a first reagent delivery network 100A will ultimately also pass through a second microfluidic network 100E3, and so forth. Thus, reagent 126a picked up and reconstituted in the reagent delivery network 100A will be sent through the reagent delivery network 100B, including the reconstituted reagent formed in the reagent delivery network 100A. Notably, processing components are not shown in this example, but may be present along the various microfluidic mixing channels. Thus, there may be processing components used that are not shown positioned prior to reaching the first reagent delivery network, between reagent delivery networks, or after passing through the multiple reagent delivery networks. Various processing that may occur at any of these locations is shown in greater detail in FIG. 11, for example. Thus, as shown, it is notable that the microfluidic inlet channels are fed from below (though orientation is not particularly an issue on the microfluidic scale, but this is mentioned for clarity in understanding fluid flow as shown in FIG. 10).

In further detail, individual outlet microfluidic channels 130 receive fluid as it passes through its microfluidic cross-channel and passes that fluid along to the next microfluidic processing channel, and so forth. The microfluidic processing channels can independently feed other architecture, such as the next reagent delivery network or an outlet 150. A system that includes a plurality of microfluidic cross-channels can include a single inlet microfluidic channel and a single outlet microfluidic channel that can respectively feed or receive a fluid there through. Each of the reagent delivery networks may have different reagents therein. The reagent delivery networks may be accessible in series or randomly. In some examples, a single fluid can be fed through the different reagent chambers. In yet other examples, multiple fluids can be fed through the different reagent chambers. Selectivity can be based on fluid flow or can be based on actuating of resistors. The fluid may be fed from the inlet microfluidic channel to the microfluidic cross-channel.

Another microfluidic processing system 200 including a reagent delivery network 100 can be utilized for temporal multiplexing as shown as microfluidic processing system 200 at FIG. 11. This FIG. depicts several fluid ports, several fluid ejectors, surface-active microparticles shown at multiple locations, several magnets for moving magnetizing surface-active microparticles, multiple detectors, etc. A microfluidic processing system for use in accordance with the present location can include or use some or all of these components, or even additional components not shown. FIG. 11 is provided to describe various processing systems that may occur along or within the processing microfluidics 210 portion of the system.

In greater detail, the microfluidic processing system 200 includes the reagent delivery network 100 as well as more complicated processing microfluidics 210 fluidly coupled together at a fluidic junction 135. The reagent delivery network in particular includes multiple microfluidic cross-channels 120 each containing a different reagent 126a, 126b, and 127c in their respective reagent storage chamber 124. As in the prior examples, there is an inlet microfluidic channel 110 (with an inlet port 250), an outlet microfluidic channel 130, and a plurality of resistors 140. In this example, the inlet port may be used to introduce fluids such as elution buffer, and the reagents can be used selectively to interact with the elution buffer based on how or when the individual resistors are energized. The reagent delivery network portion of the microfluidic processing system can operate similarly as that described previously.

Regarding the processing microfluidics 210 as shown in this example, there is a sample port 220 and a sample-receiving chamber 230 for receiving sample fluid (which may contain an analyte for processing). The processing microfluidics in this example can include or contain surface-active microparticles, which may be magnetizing microparticles, to interact with or become attracted to analyte from the sample fluid. Magnetizing microparticles can be transported within the processing microfluidics by magnets that move along the processing microfluidics. In this example, the processing microfluidics can include a microfluidic processing channel 240 to transport the sample fluid (with or without surface-active microparticles, depending on the application) in a direction toward an ejector 290 (E3) for dispensing of the fluid after processing within the microfluidic processing system. Thus, fluid and/or analyte movement can be accomplished by the use of the magnetizing microparticles, fluid pumps, ejectors, etc. For example, ejectors, shown at E1 and E2, for ejecting fluid into the microfluidic processing channel, can be implemented for fluid movement. In further detail, in this example, there are three additional secondary inlets 270 with secondary inlet microchannels 280, identified further as C1, C2, and C3 The secondary inlet microchannels located upstream of the reagent delivery network (C1 and C2) can permit loading of wash buffer, transport buffer, buffer containing reagents for downstream reactions, or the like. In the case of nucleic acid amplification, a post processing wash buffer may be introduced via another secondary inlet microchannel (C3), which can be used to wash the downstream portion of fluid after processing and/or mixing of fluids and/or reagents, e.g., a post amplification wash buffer. Washing can permit multiplexing of different analytes, e.g., nucleic acids, in a sample fluid with different sets of primers introduced sequentially using the reagent delivery network 100 described previously, Following multiplexing of a nucleic acid, for example, the microfluidic processing channel can be washed with a wash buffer, a portion of sample fluid passed into the microfluidic processing channel, and another primer multiplexed with that portion of the sample fluid. In other examples, the microfluidic processing system can include integrated chambers prefilled with buffers in addition to or in place of additional fluid inlets.

In further detail, the microfluidic processing system 200 along the microfluidic processing channel 240 can include magnets 245. The magnets can be used for collecting and/or moving magnetizing microparticles 235 that are surface-activated along the microfluidic processing channel, for example. The magnets, identified individually as M1, M2, and M3, can be movable along the microfluidic processing channel and/or can be moved closer to or further from the microfluidic processing channel, or can be electromagnetically modified to be interactive with the magnetizing microparticles or not interactive with the magnetizing microparticles. In further detail, the magnet can be capable of generating a magnetic field, such as a magnetic field that can be turned on and off by introducing electrical current/voltage to the magnet. Alternatively, the magnet can be a permanent magnet that is placed in proximity to the microfluidic processing system to effect movement of surface-activated microparticles that are magnetic or magnetizing. The magnet can be permanently placed within this proximity, or can be movable along the microfluidic processing system, or movable in position and/or out of position to effect movement of the surface-activated microparticles. Magnetic surface-activated microparticles can be magnetized by the magnetic field generated by the magnet. In addition, the magnet can create a force capable of pulling the magnetic surface-activated microparticles through the microfluidic processing system. When the magnet is turned off or not in appropriate proximity, the magnetic surface-activated microparticles can reside in place or be passed through the microfluidic processing system using fluid flow. The use of magnetic surface-activated microparticles can permit portions of the sample fluid to be passed through a microfluidic processing channel, while other portions of the sample fluid remain in the sample-receiving chamber.

One or multiple heating elements 260, e.g., thermocycling heaters, can be included along the microfluidic processing channel adjacent to or operable in association with a thermocycling heater 260 to thermocycle fluidic or fluidic microparticle mixtures prepared using the microfluidic processing system. Two thermocyling heaters are shown by way of example at H1 and H2. In some examples, the fluids after processing can be thermocycled, for example, if the nucleic acid corresponding to the primer picked up from the reagent delivery network is amplified, and amplification can be detected using a detector 260 (D1) outside the channel, for example, e.g., amplification detection with a fluorescence detector. After amplification, for example, post amplification wash buffer can be pumped through the thermocycling heater region to remove any amplified nucleic acid there as well as any primers, and the resulting fluid composition can be dispensed via an ejector 290 (E3). This wash buffer may contain reagents to degrade nucleic acids, e.g., nucleases, to prevent contamination of amplification for other runs with the same primer set.

The heating elements (or thermocycling heaters) may be integrated into the substrate or may be a separate component from the substrate. The types of heating elements that can be used include a resistive heating element, a field-effect transistor, a p-n junction diode, a thin film heater, a thermal diode, or a combination thereof. The heating element may be a resistive heating element. A resistive heating element may be coupled with a p-n junction diode. In other examples, the heating element can include a resistive heating element and a thermistor. A thermal resistor, if present, can apply heat to speed up a chemical reaction. The heating element includes a resistive heating element, field-effect transistor, p-n junction diode, thin film heater, thermal diode, or a combination thereof, and the heating element can include platinum, aluminum, copper, gold, silver, tantalum, titanium, nickel, tin, zinc, chromium, tungsten silicon nitride, tantalum aluminum, nichrome, tantalum nitride, chromium silicon oxide, poly-silicon, germanium, oxides, alloys, and combinations thereof. The heating element may be operable to heat fluid at a rate of 100° C./s to 50,000,000° C./s (e.g., pulses of heat ranging in duration from the order of hundreds of nanoseconds to milliseconds) or at a rate of 1,000° C./s to 10,000,000° C./s.

The heating element can permit consistent or pulsed heating. In some examples, the heating can be pulsed. Pulsed heating can provide suitable control in heating a fluid. In some examples, the heating element can be positioned to elevate a temperature of a fluid by 20° C. to 50° C. when pulsed on for 0.1 μs to 1 second. In an example, the heating element can be part of a microfluidic processing system that can be used for nucleic acid amplification. The heating element can allow for rapid thermal cycling and can be used to rapidly amplify a nucleic acid on time scale limits imposed by physical and chemical kinetics. Rapid thermal cycling can be used to amplify a nucleic acid within hold times from 0.05 seconds to 10 seconds, from 0.05 seconds to 1 second, from 0.5 seconds to 10 seconds, or from 0.5 seconds to 3 seconds for a denaturing, annealing, and extending phase during the amplification process. Rapid thermal cycling can be used for polymerase chain reaction, isothermal amplification, reverse transcription, forward transcription, or a combination thereof. In other examples, a continual heat can be applied for isothermal amplification. Other processes that may be carried out include loop mediated isothermal amplification (LAMP) or recombinase polymerase amplification (RPA), for example.

Regarding the detector(s) 255, two are shown at D1 and D2. A detector can be used for purposes of detecting analyte of a sample fluid along with fluids/microparticles admixed therewith that may be positioned along the microfluidic processing channel 240 as well, either associated or located at or near a magnet 245 and/or a thermocycling heater 260, or elsewhere along the microfluidic processing channel or other location. The detector may be an optical detector, for example, with an illumination source (not shown) to illuminate the fluids within the microfluidic processing channel. The optical detector can receive data relating to the analyte that may be present in the sample fluid. An illumination source can be operable to emit light towards the wall or portion of the wall of the substrate that is optically transparent. The detector can be operable to detect fluorescence emitted from a fluorescent molecule which can be loaded in the system and can become conjugated with an analyte, e.g., nucleic acid, of the sample fluid during nucleic acid amplification. In other examples, the optical detector can be located with respect to the optically transparent area such that a light beam passes through the optically transparent area onto an optical detector or to an element capable of directing the light beam to the optical detector. In some examples, an optical detector can include a band pass filter and a p-n junction diode. A band pass filter passes frequencies in a certain range while attenuating frequencies outside that range. The band pass filter can permit a fluorescing wavelength emitted by the excited fluorescent molecule, allowing a p-n junction diode is a two-terminal semiconductor capable of converting light into an electrical current when photons are absorbed in the photodiode.

In further detail regarding the surface-activated microparticles, the surfaces can be adapted to bind with a biological component or can be bound to the biological component or analyte of the sample fluid. Surface activated microparticles can include surface groups that are interactive with the analyte of the sample fluid or can include a covalently attached ligand attached to a surface of the microparticles to likewise bind with an analyte, e.g., biological component of a biological sample, or sample fluid. In some examples, the ligand can include proteins, antibodies, antigens, nucleic acid primers, amino groups, carboxyl groups, epoxy groups, tosyl groups, sulphydryl groups, or the like. The ligand can be selected to correspond with and bind with the biological component and can vary based on the type of biological component being isolated from the sample fluid or biological sample. For example, the ligand can include a nucleic acid primer when isolating a biological component that includes a nucleic acid sequence. In other examples, the ligand can include an antibody when isolating a biological component that includes antigen.

In some examples, the surface-activated microparticles can have an average particle size that can range from about 0.1 μm to about 70 μm. The term “average particle size” describes a diameter or diameter of the volume of the particles if modified to a spherical size based on the particle volume, which may vary, depending upon the morphology of the individual particle. A shape of the surface-activated microparticles can be spherical, irregular spherical, rounded, semi-rounded, discoidal, angular, sub-angular, cubic, cylindrical, or any combination thereof. In some examples, the particles can include spherical particles, irregular spherical particles, or rounded particles. The shape of the surface-activated microparticles can be spherical and uniform, which can be defined herein as spherical or near-spherical, e.g., having a sphericity of >0.84. Thus, any individual particles having a sphericity of <0.84 are considered non-spherical (irregularly shaped). The particle size of the substantially spherical particle may be provided by its diameter, and the particle size of a non-spherical particle may be provided by its average diameter (e.g., the average of multiple dimensions across the particle) or by an effective diameter, e.g., the diameter of a sphere with the same mass and density as the non-spherical particle. In further examples, the average particle size of the surface-activated microparticles can range from about 1 μm to about 50 μm, from about 5 μm to about 25 μm, from about 0.1 μm to about 30 μm, from about 40 μm to about 60 μm, or from about 25 μm to about 50 μm.

The surface-activated microparticles can be in the form of magnetizing microparticles. The term “magnetizing microparticles” is defined herein to include microparticles that may not be magnetic in nature unless and until a magnetic field is introduced at a strength and proximity to cause them to become magnetic. Their magnetic strength can be dependent on the magnetic field applied and may get stronger as the magnetic field is increased, or the magnetizing microparticles get closer to the magnetic source that is applying the magnetic field. Magnetizing microparticles can include paramagnetic microparticles, superparamagnetic microparticles, diamagnetic microparticles, or a combination thereof, for example. Commercially available examples of magnetizing microparticles that are surface-activated include those sold under the trade name DYNABEADS®, available from ThermoFischer Scientific (USA).

In more specific detail, “paramagnetic microparticles” may have the ability to increase in magnetism when a magnetic field is present; however, paramagnetic microparticles are not magnetic when a magnetic field is not present. In some examples, the paramagnetic microparticles can exhibit no residual magnetism once the magnetic field is removed. A strength of magnetism of the paramagnetic microparticles can depend on the strength of the magnetic field, the distance between a source of the magnetic field and the paramagnetic microparticles, and a size of the paramagnetic microparticles. As a strength of the magnetic field increases and/or a size of the paramagnetic microparticles increases, the strength of the magnetism of the paramagnetic microparticles increases. As a distance between a source of the magnetic field and the paramagnetic microparticles increases, the strength of the magnetism of the paramagnetic microparticles decreases. “Superparamagnetic microparticles” can act similar to paramagnetic microparticles; however, they can exhibit magnetic susceptibility to a greater extent than paramagnetic microparticles in that the time it takes to become magnetized appears to be near zero seconds. “Diamagnetic microparticles,” on the other hand, can display magnetism due to a change in the orbital motion of electrons in the presence of a magnetic field.

Regardless of the configuration, the microfluidic processing system can be manufactured as part of a microfluidic chip. In some examples, the microfluidic chip can be a lab on chip system. The lab on chip system can be a point of care system. For example, the lab on chip system can include a polymerase chain reaction lab on chip system which can include multiple reagent delivery networks connected in series along the inlet microfluidic channel, and can include different primers within each of the reagent delivery networks to allow for spectral multiplexing.

In further detail, the microfluidic processing systems 200 of FIGS. 7-11 can include elements from any of the other examples, with parts and configurations being available to be mixed and matched, as may be useful for a given application. For example, the systems may include additional fluid inlets, outlets, ports, ejectors, flow channels, reagent delivery networks, or the like. Additional fluid inlets can permit loading of fluids in the system and a location of the fluid inlets can vary based on design. The fluid inlets can permit loading of fluids into the system.

By way of example, the reagent delivery networks and/or the microfluidic processing systems of the present disclosure can be used for a variety of processes that may be tailored by an end user. For example, in a system where there is the ability for multiplexing, the reagent storage chambers may store any of a number of reagents, such as enzymes, chelating agents, primers for nucleic acid amplifications, reactants, etc. Furthermore, with multiplexing within a microfluidic network and/or multiplexing using multiple microfluidic networks connected in parallel or series fluidically, reagents may even be selected by an end user as may be desired for a given application based on results from a prior step, leveraging flexibility for on the fly processing, e.g., diagnostics, amplification, assays, cheating, enzyme processing, etc.

As a practical example, if a nucleic acid is to be amplified after a nasal swab using a multiplexing reagent delivery network such as that shown in FIG. 6, or any, of the systems shown in FIGS. 8-11, a first reagent selected for use (present in one of the reagent storage chambers) may include an enzyme to degrade mucin, which is a protein related to mucous. Next, with the mucous degraded, a second reagent (in a second reagent storage chamber) may then be used to deliver primers for amplification of the nucleic acids in the nasal swab sample fluid.

In other examples, if amplifying nucleic acids from blood, a first reagent that is reconstituted may include a chelating agent, e.g., EDTA to chelate out a portion of the iron, a second reagent could be used to add additional magnesium to compensate for the iron that has been chelated, and then additional reagent may be introduced that could include amplification primers. These components could be added sequentially with washing cycles, for example. On the other hand, when there are multiple microfluidic networks as part of a common microfluidic processing system, one network may be used to store and use the EDTA and the subsequent network may be used to add in the magnesium. Thus, multiplexing can be carried out within individual microfluidic cross-channels of a common reagent delivery network and/or multiple microfluidic mixing channels may be used to stack various processes with user flexibility.

In still other examples, one or more of the reagent delivery networks can be coupled to microfluidics and processing components for carrying out processes such as cleaning, cell lysing, reverse transcriptase (converting RNA to DNA) by heating and holding with the assistance of an enzyme, e.g., delivered from the reagent delivery network, etc.

Methods of Processing Analytes

Methods of processing an analyte are shown by way of example in FIG. 12, and can include forming 310 a capillary retention meniscus at a constriction region of a microfluidic cross-channel branching off from an inlet microfluidic channel. In this example, the microfluidic cross-channel also includes a reagent storage chamber downstream from the constriction region. The method can further include actuating 320 a resistor positioned along the inlet microfluidic channel at a location to generate a pressure change to break the capillary retention meniscus, flowing 330 the fluid through the constriction region and into the reagent storage chamber to combine with a reagent to form a reagent-containing fluid, and introducing 340 the reagent-containing fluid into the processing microfluidics through an outlet microfluidic channel. In further detail, the method can also include processing 350 the analyte in combination with the reagent from the reagent-containing fluid at a location within the processing microfluidics.

In some examples, the fluid can be an analyte-containing sample fluid and the reagent-containing fluid formed in the reagent storage chamber includes the analyte. In other examples, the method can include combining the reagent-containing fluid with an analyte-containing sample fluid at or after introducing the reagent-containing fluid into the processing microfluidics, e.g., analyte introduced upstream from where the reagent-containing fluid is introduced into the processing microfluidics. In other examples, the method can include moving the analyte along the processing microfluidics using magnetizing microparticles having an affinity for the analyte. In some examples, the method can include thermocycling the analyte within the processing microfluidics in the presence of a reagent received from the reagent delivery network. In still other examples, after introducing the reagent-containing fluid into the processing microfluidics, the method can include forming a second capillary retention meniscus at a second constriction region of a second microfluidic cross-channel branching off from an inlet microfluidic channel. The second microfluidic cross-channel can include a second reagent storage chamber downstream from the second constriction region. In this example, the method can further include actuating a second resistor positioned along the inlet microfluidic channel at a second location to generate a pressure change to break the second capillary retention meniscus, flowing the fluid through the second constriction region and into the second reagent storage chamber to combine with the second reagent to form a second reagent-containing fluid, and introducing the second reagent-containing fluid into the processing microfluidics through the outlet microfluidic channel.

In addition to actuating the resistor, the method can further include actuating a second resistor positioned along an outlet microfluidic channel fluidly having a side-wall opening connected to the microfluidic cross-channel downstream from the inlet microfluidic channel, or actuating a chamber resistor (or multiple chamber resistors) positioned within the reagent storage chamber, or actuating both. This can result in enhanced fluid movement, and/or enhanced mixing for example. Mixing can also occur, which mixing may be direct or indirect. For example, the sample fluid or a secondary fluid, such as a carrier fluid, buffer, or the like may flow into the reagent delivery network. A secondary fluid can flow through the reagent delivery network, dissolve or disperse the reagent, and flow the dissolved or dispersed reagent to the sample fluid downstream thereby permitting mixing of the sample fluid and the reagent.

The reagent delivery network can be as described herein. In some examples, the reagent delivery network may further include a chamber resistor within the reagent storage chamber. The method can further include actuating the chamber resistor and generating a pressure change at the chamber resistor to generate cross-directional fluid flow within the reagent storage chamber. In other examples, the method can include admixing the sample fluid with a variety of different reagents. The reagent delivery network can include multiple microfluidic cross-channels. The fluid can be flowed into each of the reagent storage chambers. The flowing of the fluid may be serial or in series through the plurality of the microfluidic cross-channels.

When the method is conducted with microfluidic processing systems described herein, which may include a plurality of reagent storage chambers, an inlet(s), a heating element(s), surface-activated microparticles, e.g., magnetizing with the use of a magnet, etc., the method can include multiplexing of different nucleic acids in a sample fluid. For example, the reagent in the different reagent storage chambers can include different primers. In other examples, the methods herein can include adhering nucleic acids in the sample to surface-activated microparticles, directing magnetizing surface-activated microparticles with the nucleic acids thereon with a magnet to a microfluidic processing channel, flowing carrier fluid into an inlet microfluidic channel of a reagent delivery network, forming a capillary retention meniscus at one or more microfluidic cross-channels branching off from the inlet microfluidic channel, and/or actuating a resistor positioned along the inlet microfluidic channel at a location to generate a pressure change to break the capillary retention meniscus. In further detail, the methods herein can include flowing the carrier fluid through the constriction region and into the reagent storage chamber to solubilize or suspend the reagent using the carrier fluid, actuating the resistor to direct the carrier fluid into the microfluidic processing channel where the carrier fluid joins the surface-activated microparticles, moving the carrier fluid and the magnetizing surface-activated microparticles to other areas within the system, e.g., to sensors, heating elements, etc., conducting thermal cycling, transporting fluid from the system through an outlet, ejecting the thermally cycled material using fluidjet architecture, inserting wash buffer into the system at the inlet port, or the like. These various processing steps may be used in any of a number of combinations using the microfluidic processing systems described herein, including processing where processing steps are repeating, such as to amplify a different nucleic acid in the sample fluid.

### Definitions

As used in this specification and the appended claims, the singular forms “a,” “an” and “the” include plural referents unless the content clearly dictates otherwise.

As used herein, a plurality of items, structural elements, compositional elements, and/or materials may be presented in a common list for convenience. However, these lists should be construed as though individual members of the list are individually identified as a separate and unique member. Thus, no individual member of such list should be construed as a de facto equivalent of any other member of the same list solely based on presentation in a common group without indications to the contrary.

Concentrations, dimensions, amounts, and other numerical data may be presented herein in a range format. A range format is used merely for convenience and brevity and should be interpreted flexibly to include the numerical values explicitly recited as the limits of the range, and also to include all the individual numerical values or sub-ranges encompassed within that range as if each numerical value and sub-range is explicitly recited. For example, a numeric range that ranges from about 10 to about 500 should be interpreted to include the explicitly recited sub-range of 10 to 500 as well as sub-ranges thereof such as about 50 and 300, as well as sub-ranges such as from 100 to 400, from 150 to 450, from 25 to 250, etc.

The terms, descriptions, and figures used herein are set forth by way of illustration and are not meant as limitations. Many variations are possible within the disclosure, which is intended to be defined by the following claims—and equivalents—in which all terms are meant in the broadest reasonable sense unless otherwise indicated.

The following illustrates an example of the present disclosure. Numerous modifications and alternative compositions, methods, and systems may be devised without departing from the disclosure. The appended claims are intended to cover such modifications and arrangements.

### Example

Reagent Delivery Networks for Temporal Multiplexing

A sample fluid is inserted into the microfluidic processing system using components shown in FIG. 11 through a sample port, which enters a sample-receiving chamber including magnetizing surface-activated microparticles. The microparticles react with or bind with a nucleic acid in the sample fluid. A portion of the nucleic acid reacted with the magnetizing surface-activated microparticles are moved using a magnet into the microfluidic processing channel. A carrier fluid is loaded into an inlet port forming a capillary retention meniscus at one of the openings to a microfluidic cross-channel. The resistor is activated forcing the carrier fluid into the reagent storage chamber thereby dissolving or dispersing the reagent in the carrier fluid. The carrier fluid with the reagent therein is forced into the outlet microfluidic channel by activating one or more resistors to cause flow through the outlet microfluidic channel into the microfluidic processing channel, meeting the portion of the sample fluid bound containing magnetizing surface-activated microparticles.

The surface activated microparticles along with the reagent are moved by a magnet to an area including a heating element. The magnetizing surface-activated microparticles are dissociated from sample components, and heating is cycled on and off, amplifying nucleic acid within the microfluidic processing channel. The amplified nucleic acid is then dispensed by ejection via an ejector.

A wash buffer is then flowed through an inlet port into the microfluidic processing channel to clear the flow channel in preparation for another amplification process. The process is repeated, flowing a carrier fluid through a different storage reagent chamber of the reagent delivery network including a different set of primers, allowing for the amplification of a different nucleic acid in the sample fluid.

This process is repeated a third time for a third amplification from a third set of primers from a third storage reagent chamber, for example.

While the present technology has been described with reference to certain examples, it will be appreciated that various modifications, changes, omissions, and substitutions can be made without departing from the spirit of the disclosure. It is intended, therefore, that the disclosure be limited only by the scope of the following claims.

What is claimed is:

1. A microfluidic processing system, comprising:
a reagent delivery network including an inlet microfluidic channel fluidly coupled to an outlet microfluidic channel via a microfluidic cross-channel, the microfluidic cross-channel including a constriction region and a reagent storage chamber, and
a resistor positioned along the inlet microfluidic channel at a location to redirect fluid through the constriction region and into a reagent storage chamber; and
processing microfluidics fluidly coupled downstream from the outlet microfluidic channel.

2. The microfluidic processing system of claim 1, wherein the processing microfluidics include surface-activated magnetizing microparticles contained therein.

3. The microfluidic processing system of claim 1, wherein the processing microfluidics include a thermocycling heater downstream from the reagent delivery network.

4. The microfluidic processing system of claim 1, wherein the processing microfluidics include fluid movement component to direct fluid within the processing microfluidics or to eject fluid from the processing microfluidics.

5. The microfluidic processing system of claim 1, wherein the processing microfluidics includes a sample-receiving port or chamber to receive analyte-containing sample fluid at a location upstream from where the outlet microfluidic channel is fluidically coupled with the processing microfluidics.

6. The microfluidic processing system of claim 5, wherein the processing microfluidics includes a secondary inlet microchannel or port positioned downstream from the sample-receiving port or chamber.

7. The microfluidic processing system of claim 1, wherein the reagent storage chamber contains reagent to be mixed or reconstituted by fluid passing through the constriction region and into the reagent storage chamber.

8. The microfluidic processing system of claim 1, wherein the resistor is adapted to operate at a power density sufficient to break a capillary retention meniscus at the constriction region and deliver fluid from the inlet microfluidic channel and into the reagent storage chamber.

9. The microfluidic processing system of claim 1, comprising:
multiple microfluidic cross-channels fluidically independently coupling the inlet microfluidic channel with the outlet microfluidic channel in series, wherein the multiple microfluidic cross-channels include:
the microfluidic cross-channel, and
a second microfluidic cross-channel having a second reagent storage chamber;
a second resistor positioned along the inlet microfluidic channel at a second location to cause the fluid to flow through the second constriction region and into the second reagent storage chamber, wherein actuation of the resistor causes the fluid to flow through the constriction region and does not cause the fluid to flow through the second constriction region, and wherein actuation of the second resistor causes the fluid to flow through the second constriction region and does not cause the fluid to flow through the constriction region.

10. A method of processing an analyte, comprising;
forming a capillary retention meniscus at a constriction region of a microfluidic cross-channel branching off from an inlet microfluidic channel, wherein the microfluidic cross-channel further includes a reagent storage chamber downstream from the constriction region;
actuating a resistor positioned along the inlet microfluidic channel at a location to generate a pressure change to break the capillary retention meniscus;
flowing the fluid through the constriction region and into the reagent storage chamber to combine with a reagent to form a reagent-containing fluid;
introducing the reagent-containing fluid into processing microfluidics through an outlet microfluidic channel; and
processing an analyte in combination with the reagent from the reagent-containing fluid at a location within the processing microfluidics.

11. The method of claim 10, wherein the fluid is an analyte-containing sample fluid and the reagent-containing fluid formed in the reagent storage chamber includes the analyte.

12. The method of claim 10, further comprising combining the reagent-containing fluid with an analyte-containing sample fluid at or after introducing the reagent-containing fluid into processing microfluidics.

13. The method of claim 10, further comprising moving the analyte along the processing microfluidics using magnetizing microparticles having an affinity for the analyte.

14. The method of claim 10, further comprising thermocycling the analyte within the processing microfluidics in the presence of reagent received from the reagent delivery network.

15. The method of claim 10, wherein after introducing the reagent-containing fluid into processing microfluidics, the method further comprises:
forming a second capillary retention meniscus at a second constriction region of a second microfluidic cross-channel branching off from an inlet microfluidic channel, wherein the second microfluidic cross-channel further includes a second reagent storage chamber downstream from the second constriction region;
actuating a second resistor positioned along the inlet microfluidic channel at a second location to generate a pressure change to break the second capillary retention meniscus;
flowing the fluid through the second constriction region and into the second reagent storage chamber to combine with second reagent and form a second reagent-containing fluid; and
introducing the second reagent-containing fluid into processing microfluidics through the outlet microfluidic channel.
